(19) United States
(12) Patent Application Publication
(10) Pub. No.: US 2010/0161402 A1
(43) Pub. Date: Jun. 24, 2010

(54) SYSTEM AND METHOD FOR MARKETING A WIRELESS NETWORK

(75) Inventor: Carlos E. Reyna, Orlando, FL (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/342,949

(22) Filed: Dec. 23, 2008

(51) Int. Cl. G06Q 30/00; G06Q 10/00; G06Q 50/00

(52) U.S. Cl. 705/14.32; 705/34

(57) ABSTRACT

A system and method for marketing a wireless network provided by a communications service provider may include storing merchant data records about merchants who receive communications services from the communication services provider. The merchant data records including merchant identification, communications services being received, and billing information. A request for a merchant data record may be received, and a discount may be applied to the merchant for receiving communications services from the communications service provider in response to receiving an indication that a merchant is providing wireless network access to customers in an establishment of the merchant. In one embodiment, the indication may be an entry that the merchant has posted a sign or other indicator that displays the name and/or logo of the communications service provider.

### BACKGROUND

Communication services providers have become more competitive than ever. Marketing and advertising programs that utilize traditional media have become very expensive. The combination of competition and expensive advertising can be financially difficult, even for large telecommunication service providers. The result of spending significant money often becomes marginally beneficial for communication service providers given that most consumers have existing communications service plans. As such, communication service providers seek to find alternative ways of marketing and advertising to potential customers with lower costs.

### SUMMARY

To overcome the problem of marketing and advertising programs being expensive, the principles of the present invention provide for a communications service provider providing merchants with wireless network access that may be made available to customers of the merchants free of charge. In exchange for merchants making the wireless network access available and posting a physical sign with a name and/or logo of the communication service provider (e.g., “wireless network access provided by CommServCo”), the communications service provider may provide a discount to the merchants for other communications services, such as telephone and/or data services. In addition, each merchant that offers the wireless network access to its customers may be part of a network of merchants that are provided with advertising airtime to customers who access the wireless network at the other merchants in the network. In one embodiment, a network directory of each of the merchants in the network is made available to the customers. These and other features provide low-cost advertising and marketing for the communications service provider and merchants that participate in the wireless network. The wireless network access and merchant listing in the network directory may be free of charge for customers and merchants, respectively.

One embodiment of a system for marketing a wireless network provided by a communications service provider may include a storage unit configured to store merchant data records about merchants who receive communications services from the communication service provider. The data records may include merchant identification, communication services being received, and billing information (e.g., cost for the communications services). An input/output (I/O) unit may be configured to enable communications over a communications network. A processing unit may be in communication with the storage unit and I/O unit, and be configured to (i) receive a request for a merchant data record, and (ii) in response to receiving an indication that a merchant is providing wireless network access to customers in an establishment of the merchant by operating a network access device, apply a discount to the merchant for receiving communications services from the communications service provider.

One embodiment of a method for marketing a wireless network provided by a communications service provider may include storing merchant data records about merchants who receive communications services from the communication services provider. The merchant data records including merchant identification, communications services being received, and billing information. A request for a merchant data record may be received, and a discount may be applied to the merchant for receiving communications services from the communications service provider in response to receiving an indication that a merchant is providing wireless network access to customers in an establishment of the merchant. In one embodiment, the indication may be an entry that the merchant has posted a sign or other indicator that displays the name and/or logo of the communications service provider.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an illustrative business environment in which a communications service provider provides communication services to merchants;

FIG. 2A is an illustration of an illustrative network environment in which a server of a communications service provider provides communications services to merchants, including wireless network access to customers thereof;

FIG. 2B is a screenshot of an illustrative graphical user interface in which a customer of a merchant may access a wireless network;

FIG. 3 is a block diagram of an illustrative server configured to provide for communications services, including wireless network access, at merchant premises;

FIG. 4 is a block diagram of illustrative software modules configured to provide for communications services to merchants and customers of the merchants;

FIG. 5 is an illustration of an illustrative monthly bill for a merchant receiving communications services from a communications service provider;

FIG. 6 is a screen shot of an illustrative graphical user interface configured to enable a user at the communications service provider manage an account of a merchant; and

FIG. 7 is a flow diagram of an illustrative process for marketing a wireless network provided by a communications service provider.

### DETAILED DESCRIPTION OF THE DRAWINGS

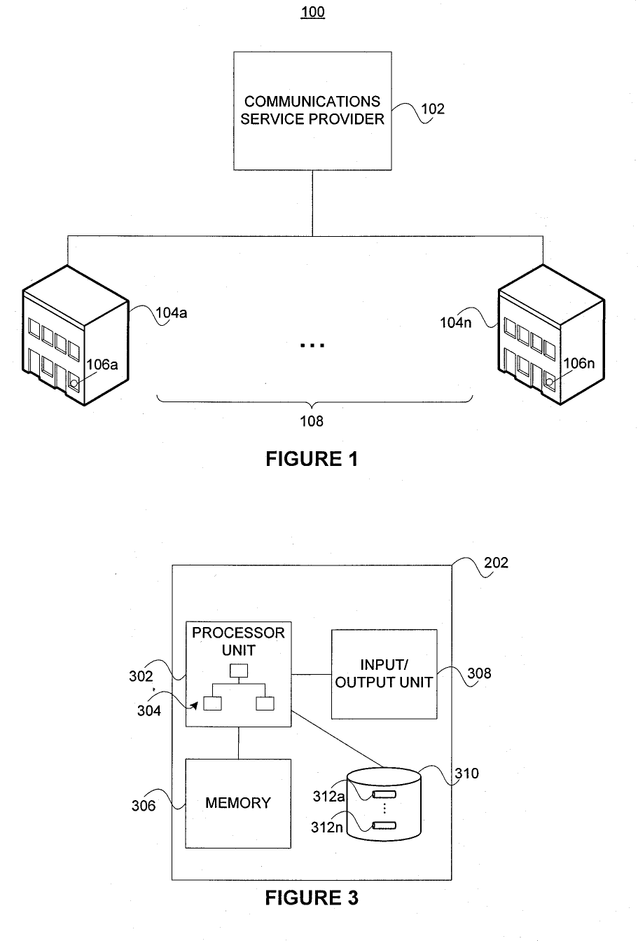

With regard to FIG. 1, an illustrative network environment 100 shows a communications service provider 102 in communication with merchants 104a-104n (collectively 104) who are customers of the communications service provider. The communications service provider 102 may be a telecommunications service provider or data communications service provider that is capable of providing telephone services and data services to merchants 104. The telecommunication services may include traditional telephone services, Wi-Fi communication services, Voice over Internet Protocol (VoIP) communication services, and so on. Data communication services may include Internet communications or any other communications (e.g., satellite) that enables the merchants to communicate data via a communications network. The merchants 104 may be any retail or non-retail merchants who sell goods and services to customers, as understood in the art. For example, one merchant may be a coffeehouse, while another merchant may be a bookstore. In another example, a merchant may be a skating rink or basketball arena, where customers are typically players and parents who attend practices and events at the arena or stadium. It should be understood that the merchants may be a wide variety of commercial operations that generally have customers from the public who the merchants desire to provide additional services to maintain customers' business and goodwill.

The communications service provider 102 may provide the merchants 104 with wireless network access that may be made available to customers of the merchants 104. The communications service provider 102 may provide the wireless network access free of charge to customers of the merchants 104 in exchange for the merchants 104 making the wireless network access available to the customers and posting physical signs 106a-106n (collectively 106) to make customers aware that the wireless network access is available from the communications service provider 102 at the respective merchant's establishment. In one embodiment, the physical signs 106 may be stickers or other display material that may be posted in a window of a merchant. Alternatively and/or additionally, the signs 106 may be posters, lettering, or any other visual display, that may be posted within or external of the premises of the merchants 104 so as to notify customers of the availability of the wireless network access. The signs 106 may include text, graphics (e.g., logo), or combination thereof that may include a trademark of the communications service provider 102, thereby providing marketing and advertising for the communications service provider 102 at a relatively inexpensive discount rate as compared to traditional forms of media advertising and marketing.

In exchange for the merchants 104 displaying signs 106 to notify customers that wireless network access is available at the merchants' establishments, the communications service provider 102 may provide each of the respective merchants a discount on communications services, such as telecommunications and data communications. In another embodiment, the communications service provider 102 may provide discounts on physical communications equipment that the merchants 104 use to access communications networks, as understood in the art. For example, the communications service provider 102 may provide the merchants 104 with discounted or free modems, telephones, servers, or any other communications device, as understood in the art. In addition, each of the merchants 104 may become part of a merchants' network 108 that receives additional benefits in becoming “advertisers” of the communications service provider 102 by posting the signs 106. As a member of the merchant network 108, each of the merchants 104 may be provided with free or discounted listings in merchant network directory that each of the customers of any of the merchants 104 may view or otherwise interface.

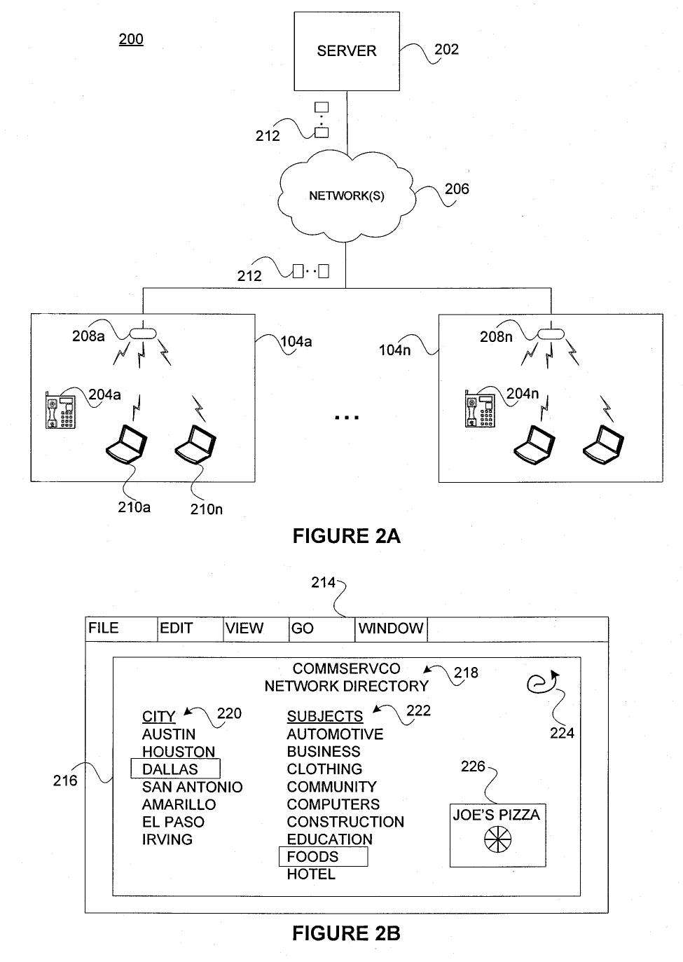

With regard to FIG. 2A, an illustrative network environment 200 may include a server 202 that is operated by a communications service provider for providing, facilitating, and/or provisioning communications services to merchants 104. The merchants 104 may include telecommunications equipment, such as telephones 204a-204n (collectively 204) that may communicate via network(s) 206. The telecommunications equipment 204 may be telephones that customers may call to or be called from the merchants 104. Each of the merchants 104 may be provided with wireless network access devices or network access devices 208a-208n (collectively 208). The network access devices 208 may enable customers who utilize laptop computers 210a-210n (collectively 210), Wi-Fi telephones, VoIP telephones, or any other electronics device that is configured to communicate over a wireless network. In one embodiment, the network access devices 208 may be configured to communicate using the 802.11 communications protocol or any other communications protocol that portable or handheld devices may utilize in accessing a network, such as the Internet.

Customers of the merchants 104 that use computers 210 may communicate with the server 202 or other network systems utilizing data packets 212 for communicating data and voice content. In one embodiment, the server 202 may generate and communicate login access to the computers 210 to enable the computers 210 to log onto the network access device 208a to access the network(s) 206. In addition, the server 202 may be configured to provide a network directory that includes a listing of each merchant in the merchant network. In one embodiment, the merchants may be categorized by geographic region and subject (see FIG. 2B). Furthermore, customers may interface within a graphical user interface that is provided by the server 202, where the graphical user interface includes at least a portion or window that is reserved for advertisements of merchants in the merchant network. The merchants may receive the advertising space free of charge or at a discount to be displayed to customers who access the network access devices 208 when at establishments of the merchants 104. The advertisements may be graphical images that are randomly or non-randomly selected for display to the customers, as understood in the art. For example, the advertisements may be displayed each time a user accesses a different webpage and be displayed to customers that are in the general vicinity (e.g., within a block, mile, five miles, city, area code, zip code, etc.).

With regard to FIG. 2B, a screenshot of an illustrative graphical user interface (GUI) 214 is shown. The graphical user interface 214 may be a window of an operating system, as understood in the art. Within the graphical user interface 214, a network directory 216 may be presented to a user. The name of the communications service provider 218 may be displayed at the top of the network directory 216 listings of geographic regions 220 subjects of merchants 222 who participate in the merchant network may be presented to the user. As understood in the art, a customer may select a city, such as Dallas, and subject, such as foods, so as to locate food merchants, such as coffee shops, bakeries, restaurants, or other food merchants, in the vicinity of the city of Dallas. The listings of geographical regions 220 and subjects of merchants 222 may include sub-listings in a hierarchical manner (e.g., state, city, zip code, region, block, street; sports venues, football, soccer, baseball, parks, arenas, rinks, etc.).

The network directory 216 may also display a logo 224 of the communications service provider, thereby providing additional brand recognition by customers of the merchants. During an entire session for a customer, the logo 224 may be displayed so as to further promote the communications service provider. Furthermore, advertising space 226 may be displayed, where the advertisement is associated with a subject (e.g., Foods) selected by the customer prior to displaying sub-subjects of foods (e.g., coffee shops, bakeries, doughnuts, restaurants, etc.) in a hierarchical manner. It should also be understood that the customer may be presented with a conventional browser interface in response to accessing the wireless access device to enable the customer to freely “surf the web”. In the browser window, advertising space may be displayed for the customers in addition to paid advertising space. The advertising space may be in the form of text listings, banner ads, side-bar listings or images, or any other advertising techniques as understood in the art. Any form of textual, graphical, photo, or video advertising space may be provided for customers when utilizing the network access device to access the network(s) 206 (FIG. 2A). The communications service provider may reserve at least one ad space per screen for merchants in the merchant network at discount or no cost.

With regard to FIG. 3, server 202 may include a processing unit 302 that is formed of one or more computer processors that execute software 304. The software 304 may be configured to manage information associated with the merchants, communications services provided to the merchants, network access devices provided to the merchants to enable customers to access communications networks, and billing information associated with the merchants. The processing unit 302 may be in communication with a memory 306 that may store data and software, input/output (I/O) unit 308 that may communicate data over one or more networks, and storage unit 310 that may be configured to store one or more data repositories 312a-312n (collectively 312). The data repositories 312 may be one or more databases that store information associated with merchants, customers of merchants, advertisements of merchants, communications equipment at the merchants, billing information of the merchants, and any other information that enables the communications service provider to provide communication services to the merchants and customers at the merchants who access a network access device while at the establishments of the merchants.

TABLE I is an illustrative set of information including merchant data records that enables the communications service provider to provide communication services to merchants listed in the table. The table may include merchant information, including ID, name, address, and telephone number. In addition, merchant communication services, including telephone service plan and data service plan, may be stored in the table. Telephone service fees and data service fees associated with each service plans may be listed. In addition, to track which merchants are providing wireless network access to its customers, a wireless network access fees data field, wireless network access address, and telephone service discount may be stored, thereby enabling the communication service provider to monitor which merchants are providing wireless network access to its customers and receiving discounts. As shown, the wireless network access fees may be set to zero or discounted from typical wireless network access fees or service rates. In one embodiment, the percent discount to each of the merchants that provide wireless network access and promote the communications service provider with a physical display in its establishment may be the same for each merchant. Alternatively, depending on the field of the merchants, the percent discount may be different as it may take additional incentive for merchants in different fields to be motivated to provide wireless network access to its customers. It should be understood that additional data fields, such as a “branding” data field that indicates whether or not a merchant is displaying a physical sign advertising the communications service provider, may be included TABLE I to provide sufficient information for the communications service provider to provide for the functionality as described herein.

TABLE I

| | | | | Merch. | Merch. | | | Wireless | | |
|---|---|---|---|---|---|---|---|---|---|---|
| | | | | Tel. | Data | Tel. | Data | Network | Wireless | |
| Merch. | Merch. | Merch. | Merch. | Serv. | Serv. | Serv. | Serv. | Access | Network | Tel. Serv. |
| ID | Name | Addr. | Tel. No. | Plan | Plan | Fees | Fees | Fees | Addr. | Discount |
| 7614 | Coffee | 123 Elm | 214-555-1234 | Service | Data | $130 | $60 | $0 | 014.37.21.3 | 10% |
| | Haus | Dallas | | One | One | | | | | |
| 0294 | Dough | 987 Park | 212-555-4321 | Service | Data | $120 | $40 | $20 | 123.41.3.81 | 10% |
| | Boys | New York | | Two | Two | | | | | |
| 2082 | Fenway | 111 Ball | 617-595-9876 | Service | Data | $180 | $120 | $20 | 714.11.4.66 | 15% |
| | Park | Park | | Three | Three | | | | | |
| | | Boston | | | | | | | | |
| . . . | . . . | . . . | . . . | . . . | . . . | . . . | . . . | . . . | . . . | . . . |

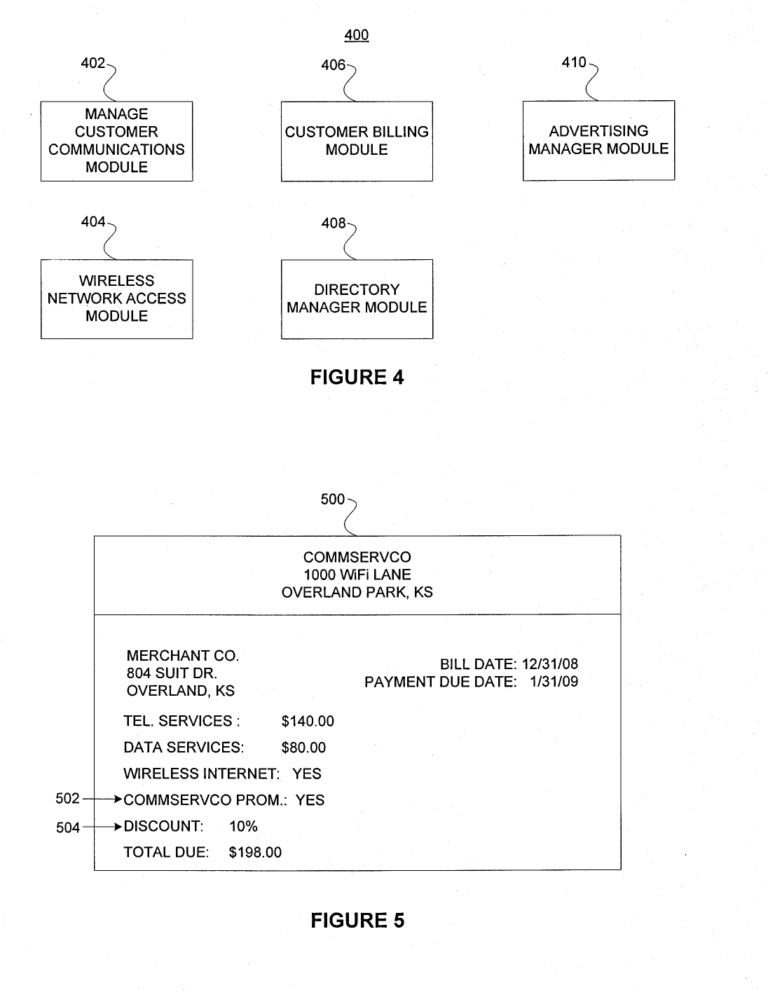

With regard to FIG. 4, in a block diagram of illustrative software modules 400 that may be used to provide the functionality of the software 304 of FIG. 3 are shown. The software modules 400 may include a managed customer communications module 402, wireless network access module 404, customer billing module 406, directory manager module 408, and advertising manager module 410.

The managed customer communications module 402 may be configured to manage conventional customer communications, including telephone services and data services. In managing the customer communications, the managed customer communications module 402 may be configured to store customer physical address information, telephone number information, network address information, and other provisioning information, as understood in the art.

The wireless network access module 404 may be configured to store and manage information associated with providing a wireless network access device. The wireless network access module 404 may manage communications protocols, hardware information, and other information that the communications service provider may utilize to provide wireless communications to customers of merchants.

The customer billing module 406 may be configured to manage monthly fees for merchants for providing telephone and data services. The customer billing module 406 may be configured to determine whether a merchant is providing wireless network access to its customers and displaying a sign or other indicator that is promoting the communications service provider for advertising purposes of the communications service provider. If so, the customer billing module 406 may be configured to apply a discount to the customer's (i.e., merchant's) communications services. In addition or alternatively, the customer billing module 406 may provide a discount for a purchase of hardware, such as telephones, wireless devices, servers, etc. In applying the discount, the customer billing module 406 may multiply the billing information for communications services by the discount, if a percentage, or subtract the discount from the billing information, if a fixed value.

The directory manager module 408 may be configured to manage a directory of merchants who are participants in the merchant network, where each merchant in the merchant network provides wireless network access to its customers at its establishments and displays a sign or indicia that indicates that wireless network access is provided at the establishment. The directory may be organized by geographic area and category of business that each merchant is providing goods and services. The directory may also be searchable for merchants in the merchant network from a particular merchant based on distance or any other data element associated with the merchants, as understood in the art.

The advertising manager module 410 may be configured to manage advertisements of the merchants in the merchant network for display to customers that are accessing a wireless network via a wireless network access device located at any of the merchants in the merchant network. The advertising manager module 410 may be configured to distribute advertisements of the merchants in a random or non-random manner, such that advertisements of each merchant are displayed to customers based on a variety of factors, including based on geographic proximity of a customer, subject matter relevance of a merchant in which a customer is accessing the wireless network, or any other factor (e.g., based on search criteria in the merchant directory or other search engine). The advertising manager module 410 may further be configured to monitor advertisement selections by customers and, in one embodiment, collect “click revenue” from merchants based on customers selecting the advertisements of the merchants. Furthermore, the advertisement manager module 410 may identify each of the merchants who participate in providing wireless network access so as to form a merchant network. A data field representative of a cost for the merchants in the merchant network may be stored in each data record of the identified merchants in the merchant network. In one embodiment, the cost may be set to zero, thereby enabling each to advertise within the merchant network for free. In distributing the advertisements, the advertising manager module 410 may access network addresses of wireless network access devices to communicate the advertisements to wireless devices being operated by customers who are accessing the wireless network.

With regard to FIG. 5, an illustrative paper bill 500 from a communications service provider to a merchant customer is shown. The bill 500 may include charges and fees for telephone services and data services. The bill 500 may further show that wireless Internet services are provided at the merchant establishment for customers of the merchant to access the Internet wirelessly. A listing 502 indicating that a promotion of the communications service provider is being displayed at the establishment of the merchant may also be shown. The promotion may include a sign or other indicia as confirmed by someone who visually inspects the establishment for placement of the promotional material (e.g., sign or sticker in window of establishment). If the promotion is being prominently displayed at the merchant's establishment, then a discount 504 may be printed on the bill and used to discount telephone services and data services, for example. The discount may be a percentage of the services or a fixed amount (e.g., $25). It should be understood that an electronic bill may also be generated and distributed to the customer in accordance with the principles of the present invention.

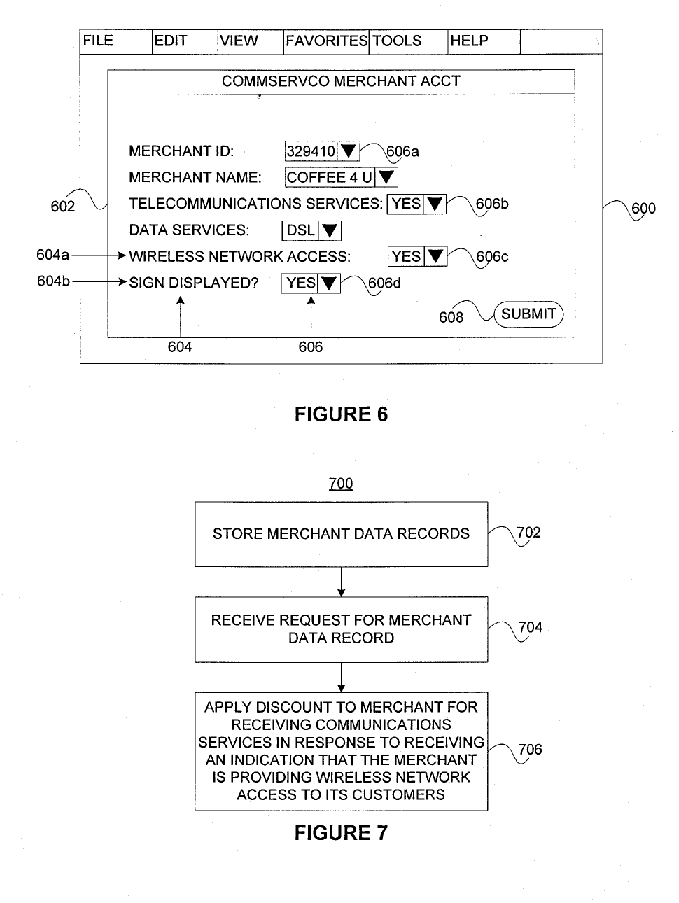

With regard to FIG. 6, a screen shot of an illustrative graphical user interface (GUI) 600 may be configured to enable a user at the communications service provider manage an account of a merchant. The GUI 600 may be a browser window in which an application window 602 may operate. Alternatively, the GUI 600 may be an application that is dedicated to managing customer accounts. Depending on a computer platform, the application may be a graphical user interface (e.g., personal computer system) or text-based interface (e.g., mainframe system).

The application window 602 may provide a number of parameter names (e.g., merchant ID, merchant name, telecommunications services, etc.) 604 and data entry fields 606. The data entry fields may be text entry fields 606a and pull-down menus 606b with selectable entries. As shown, one parameter name may include “wireless network access” parameter name 604a with a corresponding pull-down menu 606c, which, as “YES” is selected, indicates that the merchant offers wireless network access to its customers. Furthermore, a “SIGN DISPLAYED” parameter name 604b may be provided for the communications service provider to indicate that someone has physically inspected the premises of the merchant and seen a sign or other indicia, such that pull-down menu 606d may be used to select “YES.” It should be understood that alternative and/or additional parameters and entry interface elements may be utilized to provide for the same or similar functionality. Once the user, has completed filling in the parameters, the user may select the soft-button 608 to submit the information to one of the data repositories 312 operating on server 202 (FIG. 3) for storage in a data record of the merchant. If the “SIGN DISPLAYED” parameter is selected as “YES,” then an indication or “branding” confirmation may be communicated to the data repository 312 for storage therein in a “branding” data field. A discount may be given in response to receiving and/or identifying that the merchant is displaying a sign with the communications service provider's name and/or logo (i.e., advertising for the communications service provider). The discount may be stored in the data record of the merchant and processed with billing information for communications services (e.g., telecommunications and data services) by multiplying the discount, if a percentage, or subtracting the discount, if a fixed value.

With regard to FIG. 7, a flow chart of an illustrative process 700 for marketing a wireless network provided by a communications service provider is shown. The process 700 starts at step 700, where merchant data records about merchants who receive communications services from the communication services provider are stored. The merchant data records may include merchant identification, communications services, and billing information. A request for a merchant data record is received at step 702. In one embodiment, the request may be received for generating a bill for the merchant. At step 704, a discount may be applied to the merchant for receiving communications services from the communications service provider in response to receiving an indication that a merchant is providing wireless network access to customers in an establishment of the merchant. In applying the discount to the merchant, the discount may be stored in the merchant data record. At step 706, in generating a communications services bill for the merchant, the discount stored in the merchant data record may be printed on the bill and calculated to determine a final bill amount. In one embodiment, the discount is provided in the form of a percentage (e.g., 10% discount on telephony services). Alternatively, the discount may be in the form of a fixed fee (e.g., $15 discount per month or one-time $100 discount).

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A system for marketing a wireless network provided by a communications service provider, said system comprising:
a storage unit configured to store merchant data records about merchants who receive communications services from the communication service provider, the data records including merchant identification, communication services, and billing information;
an input/output (I/O) unit configured to enable communications over a communications network;
a processing unit in communication with said storage unit and I/O unit, said processing unit configured to:
receive a request for a merchant data record; and
in response to receiving an indication that a merchant is providing wireless network access to customers in an establishment of the merchant by operating a network access device, apply a discount to the merchant for receiving communications services from the communications service provider.

2. The system according to claim 1, wherein the communications services are telecommunication services utilized to place and receive telephone calls to and from customers.

3. The system according to claim 1, wherein the discount for the communication services provider is stored in a data field, and wherein said processing unit is further configured to:
process the billing information and discount; and
generate a bill for the communications service provider.

4. The system according to claim 1, wherein the billing information includes a data field representative of a fee for processing the wireless network access to customers, and wherein said processing unit is further configured to set the data field to a discounted service rate in response to receiving the indication that the merchant is providing wireless network access free to its customers.

5. A system according to claim 1, wherein said processing unit is further configured to identify each merchant that elects to provide wireless network access to its customers, thereby forming a merchant network.

6. The system according to claim 5, wherein the billing information further includes an advertising data field representative of a cost for a merchant in the merchant network to communicate advertisements to customers receiving wireless network access in any other merchant premise in the merchant network.

7. The system according to claim 6, wherein said processing unit is further configured to set the advertising cost data field to zero.

8. The system according to claim 1, wherein identification of the merchants includes a network address of a network access device located at a respective merchant, and wherein said processing unit is further configured to provide at least one of the network addresses stored in the merchant data records in response to a request for the at least one of the network addresses to which an advertisement for the merchant who has elected to provide wireless network access to customers is to be routed.

9. The system according to claim 1, wherein the merchant data records further include a branding data field, and wherein said processing unit is further configured to, in response to receiving a branding confirmation, which indicates that a physical image of an indicia representative of a brand associated with the communication service provider is being displayed at premises of the merchant, set the branding data field to a positive value.

10. The system according to claim 9, wherein said processing unit is further configured to:
determine whether the branding data field of a merchant is set to a positive value; and
in response to determining that the branding data field is set to a positive value, the indication that the merchant is providing wireless network access.

11. A method for marketing a wireless network provided by a communications service provider, said method comprising:
storing merchant data records about merchants who receive communications services from the communication services provider, the merchant data records including merchant identification, communications services, and billing information;
receiving a request for a merchant data record; and
applying a discount to the merchant for receiving communications services from the communications service provider in response to receiving an indication that a merchant is providing wireless network access to customers in an establishment of the merchant.

12. The method according to claim 11, wherein providing communications services to merchants includes providing telecommunication services utilized to place and receive telephone calls to and from customers remotely located from establishments of the merchants.

13. The method according to claim 11, further comprising:
storing the discount in the merchant data record;
processing the billing information and discount; and
generating a bill that includes the discount for the merchant.

14. The method according to claim 1, wherein storing merchant data records includes storing a data field representative of a fee for providing the wireless network access to customers of merchants, and further comprising setting the data field to a discounted service rate in response to receiving the indication that the merchant is providing wireless network access free to its customers.

15. The method according to claim 11, further comprising identifying each merchant that elects to provide wireless network access to its customers, thereby forming a merchant network.

16. The method according to claim 15, wherein storing the merchant data records includes storing an advertisement cost data field representative of a cost for a merchant in the merchant network to communicate advertisements to customers receiving wireless network access in any other merchant establishment in the merchant network.

17. The method according to claim 16, further comprising setting the advertising cost data field to zero.

18. The method according to claim 1, further comprising storing a network address of a network access device located at a respective merchant, and further comprising providing at least one of the network addresses stored in the merchant data records in response to a request for the at least one of the network addresses to which an advertisement for the merchant who has elected to provide wireless network access to customers is to be routed.

19. The method according to claim 11, further comprising storing a branding data field in the merchant data records, and in response to receiving a branding confirmation, which indicates that a physical image of an indicia representative of a brand associated with the communications service provider is being deployed at premises of the merchant, setting the branding data field to a positive value.

20. The method according to claim 19, further comprising:
determining whether the branding data field of a merchant is set to a positive value; and
a response to determining that the branding data field is set to a positive value, setting the indication that the merchant is providing wireless network access.
